(19) United States
(12) Patent Application Publication
(10) Pub. No.: US 2014/0257929 A1
(43) Pub. Date: Sep. 11, 2014

(54) VISUAL QUESTION SELECTION

(71) Applicant: BENBRIA CORPORATION, Ottawa (CA)

(72) Inventors: Ying Du, Ottawa (CA); William Curtis Collins, Nepean (CA)

(73) Assignee: BENBRIA CORPORATION, Ottawa (CA)

(21) Appl. No.: 13/791,956

(22) Filed: Mar. 9, 2013

(51) Int. Cl. G06Q 30/02

(52) U.S. Cl. CPC G06Q 30/0203
USPC 705/7.32

(57) ABSTRACT

A system for an online survey comprising a server, said server coupled to at least one user device by a network; said server operative to select a first query for a user, and one or more options to respond to the first query; transmit a first set of signals to the at least one user device, wherein said first set of signals comprise the first query and one or more options to respond to the first query; receive, from the user device, a first response based on the one or more options to respond; select a second response and one or more options to respond to the second query based on said first response; and transmit a second set of signals to the at least one user device, wherein said second set of signals comprise the selected second response and one or more options to respond to the second query.

### FIELD OF THE INVENTION

The present disclosure relates to online surveys, specifically systems and methods to generate user interfaces for online surveys.

### BRIEF SUMMARY

A system for an online survey comprising a server, said server coupled to at least one user device by a network; said server operative to select a first query for a user, and one or more options to respond to the first query; transmit a first set of signals to the at least one user device, wherein said first set of signals comprise the first query and one or more options to respond to the first query; receive, from the user device, a first response based on the one or more options to respond; select a second response and one or more options to respond to the second query based on said first response; and transmit a second set of signals to the at least one user device, wherein said second set of signals comprise the selected second response and one or more options to respond to the second query.

A method for an online survey comprising transmitting, to at least one user device, a set of signals comprising at least a first query and options to respond corresponding to said first query, said transmitting performed by a server, and said at least one user device coupled to said server by a network; and receiving, at said server from said user device, a first response based on said options to respond. In response to receiving said first response, performing processing at said server, said processing comprising selecting a second query, and options to respond to said second query; and transmitting a second set of signals to the at least one user device, wherein said second set of signals comprise the selected second query and one or more options to respond to the second query.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example implementation

FIG. 2 shows a flowchart detailing the operation of the system

FIG. 3 shows user interface 300

FIG. 4 shows user interface 400

FIG. 5 shows user interface 500

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

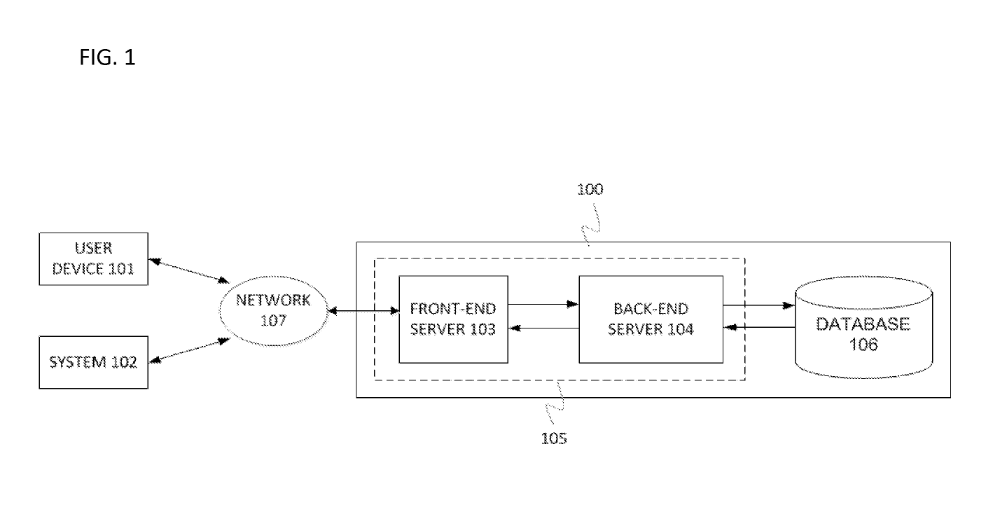

FIG. 1 shows an example architecture to implement the system and method detailed within this specification. In FIG. 1, user device 101 and system 102 are coupled to enterprise system 100 via network 107. User device 101 may be, for example, a laptop, smartphone, personal computer, tablet, kiosk or an in-store display. System 102 is, for example, a corporate system or an in-house system. Network 107 is, for example, an internal network or an external network, telephone network, local area network, wide area network, personal area network, mesh network, the Internet, or wireless network. Network 107 may comprise a plurality of subnetworks.

Enterprise system 100 comprises server 105 and database 106. In one embodiment, server 105 comprises front-end server 103 and back-end server 104. Server 105 performs processing of data received from user device 101 and system 102, retrieval of data from database 106, generation of data and commands to enable display of user interfaces at user device 101, and transmission of data to user device 101 and system 102. In the embodiment where server 105 comprises a front-end server and back-end server, the front-end server performs the functions of transmitting data to, and receiving data from the user device 101 and system 102, while the back-end server performs processing and retrieval of data from the database. In one embodiment, both the front-end server and back-end server perform processing.

In some embodiments, server 105 is implemented using a networked embodiment, wherein front-end server 103 resides on a different subnetwork from back-end server 104 and database 106, and in order to improve security, the back-end server and database are separated from the front-end server by a firewall.

Database 106 stores data including queries and options corresponding to queries, user data, and other relevant data to enable operation of the enterprise system 100.

Various implementations of enterprise system 100 are possible. For example, in one implementation, enterprise system 100 is implemented using a server or servers. In another implementation, it is implemented as a cloud-based implementation. In other implementations, it is implemented in software, hardware or a combination of software and hardware.

Similarly, various implementations of the components of enterprise system 100, that is, the front-end server 103, back-end server 104, and database 106 are possible. In one implementation, these components are implemented using a server or servers. In another implementation, these components are implemented using a cloud-based implementation. In other implementations, these components are implemented in software, hardware or a combination of software and hardware.

In one embodiment, enterprise system 100 may be used by a hosted service provider to provide a Software as a Service (SaaS) offering to an organization such as a corporation. The organization uses system 102, which communicates with enterprise system 100.

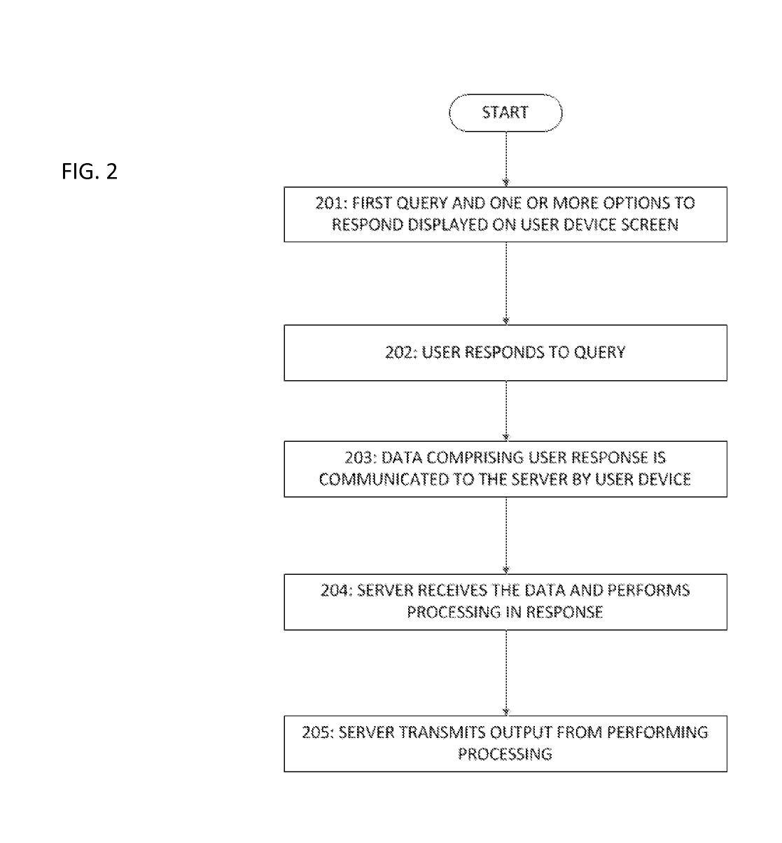

FIG. 2 shows a detailed flowchart which describes the operation of the system and method which is the subject of this detailed description. While the description below refers to user device 101, the same description can be applied to system 102.

In FIG. 2, the following is shown. In step 201, a first query and one or more options to respond to the first query, is retrieved by server 105 from database 106 and transmitted to the user device 101. A query could be, for example, a request or a prompt to enter a comment; a survey question; or an instruction. Options to respond to the query could be, for example, a list or drop down menu comprising a plurality of answers, a slider, a choice of colours, a choice of date and time, entering a comment, and giving the user a choice to upload a document, an image or other file. The first query and the one or more options to respond to the first query are displayed to the user on the screen of the user device 101. In one embodiment, the first query is a question, and the one or more options to respond to the first query is a first plurality of answers. In one embodiment, the first plurality of answers is displayed in interactive text or interactive graphic form. Examples of interactive graphic form include icons, “like” and “unlike” buttons. In one embodiment, the first query and the one or more options to respond to the first query are displayed at the user device 101 as part of a user interface. The data and code describing the user interface is generated by the server 105, which then transmits the data and code to the user device 101 which renders the user interface for the user.

In step 202, the user utilizes the user device 101 to respond to the query. For example, in the case where the one or more options to respond is a first plurality of answers, the user responds to the first query by selecting a first answer from the first plurality of answers. This can be achieved by, for example, clicking, or touching the interactive text or interactive graphic on a touch screen, corresponding to the user's desired answer.

In step 203, data comprising the user response is communicated to the server 105 by the user device 101. In another embodiment, if the network connection to the server from the user device 101 is down, the data is stored at the user device 101 at, for example, a local storage unit such as a hard disk drive or a flash drive. When the connection is re-established, the locally stored data is submitted to the server.

In step 204, the server 105 receives the data, and performs processing in response to receiving the data. During this processing, the server 105 may retrieve data from database 106.

In step 205, the server 105 transmits an output from performing the processing in step 204 to the user device 101. In one embodiment, the output comprises data and code to enable the display of at least the first query and the response to the first query.

Other forms of processing and transmitting of output are possible. In another embodiment, the operation to generate the display of at least the first query and the response to the first query in a new user interface is performed at the “client-side”, that is by user device 101. In this embodiment, at least some of the data and code to enable the display of at least the first query and the first response is transmitted as part of the code sent by the server in step 201.

In a further embodiment, the processing performed in step 204 by server 105 comprises selecting a second query and one or more options to respond to the second query. This could be, for example, a second question and a second plurality of answers. In step 205, data comprising the second query and the one or more options to respond are transmitted by the server to the user device 101. Then, the user device 101 generates a new user interface at the “client-side” comprising the first query, the response to the first query, the second query, and the one or more options to respond to the second query.

In a further embodiment, in step 204, the processing performed by server 105 comprises generating a new user interface comprising the first query, the first response, the second query and the one or more options to respond to the second query. For example, the new user interface could comprise the first question, the selected first answer, the second question and a second plurality of answers corresponding to the second question. The server 105 then transmits data in step 205 to enable display of the generated user interface comprising the first query, the selected first option, the second query and the one or more options corresponding to the second query at the user device 101.

In another embodiment, in steps 204 and 205, the server performs processing and then transmits data and code to enable “refreshing” of the previous user interface displayed on the user device 101. For example, if the one or more options to respond to the first query comprises a first plurality of answers, and the user responds by selecting an answer, then in steps 204 and 205 the server performs processing and transmits data and code to the user device so as to refresh the user interface at the user device.

In one embodiment, as part of the refreshing process, the unselected answers “disappear” from the user interface, and the second question and the second plurality of answers to the user device appear. Then, the refreshed user interface comprises the first question, the selected first answer, the second question and the second plurality of answers.

In another embodiment, the refreshing process comprises merely appending the second question and the second plurality of answers to the user device.

In yet another embodiment, at least some data and code to enable “refreshing” is transmitted as part of the code sent by the server in step 201. Then in step 204 the server selects a second query and one or more options to respond to the second query, and in step 205 this second query and corresponding one or more options is transmitted to the user device. Then, the generation of the user interface as part of the refresh operation is performed on the “client-side”.

In one embodiment, the user device 101 performs the following operations:
The first response is displayed within the user interface;
Options to respond to the first query other than the selected response “disappears” from the user interface;
The second query appears within the user interface; and
The one or more options to respond to the second query also appear within the user interface.

In another embodiment, the user device 101 simply appends the second query and the one or more options to respond to the second query to the first query and the options to respond to the first query.

In one embodiment, steps 202-205 are repeated multiple times. During each repetition, a query and one or more options to respond to the query are presented to the user. The user selects an option from the one or more options, and the selection is then transmitted to the server. Based on the selection, the server performs further processing, and transmits data to the user device to enable the display of a user interface comprising the queries and responses during each previous repetition; and a new query and one or more options to respond based on the further processing. At the final repetition, the server transmits data to enable the display of a user interface comprising the queries and responses during each previous repetition, and a final query and options to respond to the final query.

In another embodiment, similar to as described above, at least some of the data and code to enable the display of at least previous queries and previous responses was transmitted as part of the code sent by the server in step 201. Then at each repetition, the server performs processing and sends data corresponding to a new query and one or more options to respond to the new query. The user device 101 then generates a new user interface, or refreshes the previous user interface at the client-side. In one embodiment, the new user interface or the refreshed user interface displays the queries and responses chosen during each previous repetition; and a new query, and one or more options to respond to the new query. In another embodiment, the new query and one or more options to respond to the new query are appended to the one or more existing queries and options to respond to the existing queries.

For example, there may be five repetitions in total, and in each repetition the query could be a question, and the one or more options for each repetition could be a plurality of answers. Referring to the example above, at the 5^{th} repetition, a user interface is presented on the screen of user device 101 containing the first question and selected first answer; the second question and selected second answer, the third question and selected third answer; the fourth question and selected fourth answer; and finally a fifth question and a plurality of answers to respond to the fifth question.

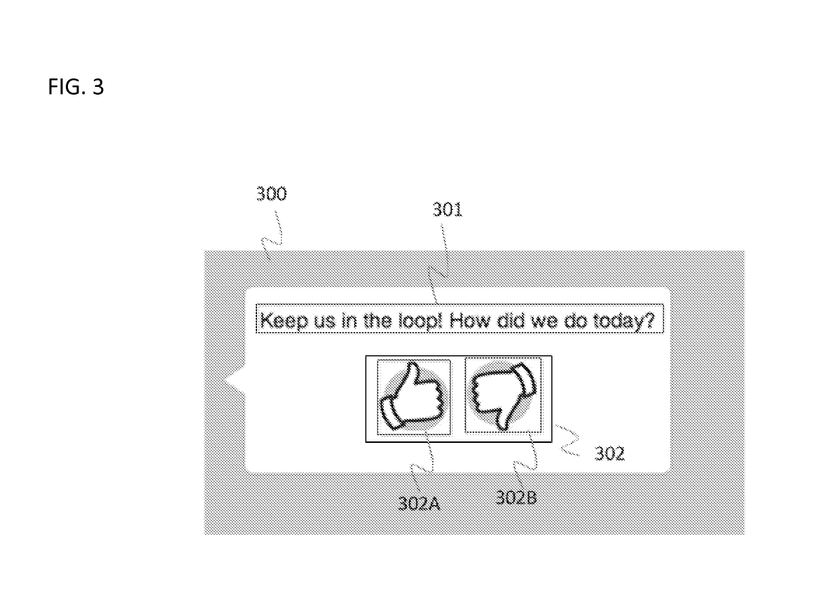

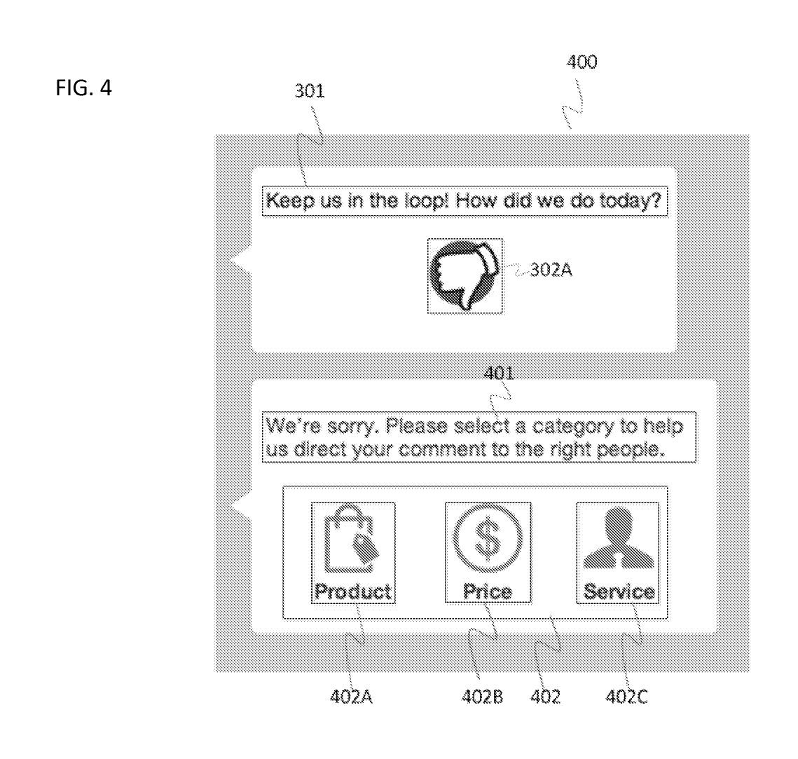

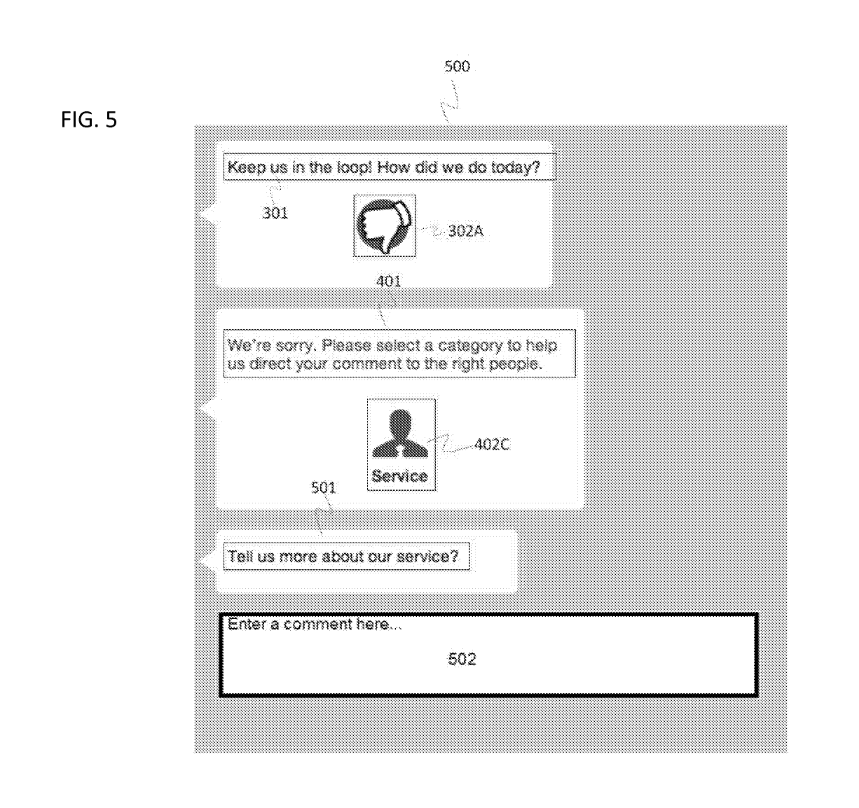

Another example is presented in FIGS. 3-5. FIG. 3 shows user interface 300 seen by the user at the start of the process. As previously explained, the server 105 transmits data to enable the display of user interface 300 at user device 101. User interface 300 comprises query 301 which is the question “Keep us in the loop! How did we do today?,” and one or more options 302 containing options 302A (thumbs up icon) and 302B (thumbs down icon) to respond to query 301 is also shown. If the user selects, for example, 302A, then user interface 400 as shown in FIG. 4 is displayed on the screen of user device 101. Methods to create this display have been described above. User interface 400 comprises query 301, a response comprising option 302A, query 401 “Awesome! Please select a category to help us direct your comment to the right people” and options to respond 402 containing options 402A (Product icon), option 402B (Price icon), option 402C (Service icon). If the user selects option 402C, then the final repetition is reached. During this repetition, user interface 500 as shown in FIG. 5 is displayed on the screen of user device 101. Methods to create this display have been described above. User interface 500 comprises query 301, a response comprising option 302A, query 401, a response comprising option 402C, query 501 “Tell us more about our service” and a field 502 for a user response.

In another embodiment, the number of remaining repetitions and the types of queries depend on the response during each repetition.

While “server-side” and “client-side” methods relating to generation or refreshing of the user interface have been described above, implementation is not limited to only these methods. In a further embodiment, generating or refreshing of the user interface is implemented using a combination of the “server-side” and “client-side” methods.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

1. An enterprise system for an online survey comprising:
a server, said server coupled to at least one user device by a network; and
wherein said server
selects a first query for a user, and one or more options to respond to the first query;
transmits a first set of signals to the at least one user device, wherein said first set of signals comprises
the first query and one or more options to respond to the first query,
data and commands to generate a first user interface at the said user device, and
data and commands to refresh said first user interface at said user device, further wherein said data and commands to refresh said first user interface comprise data and commands to enable the disappearance of all of the options to respond to the first query, except for a first response selected by the user based on the one or more options to respond;
receives, from the user device, the selected first response;
selects a second query and one or more options to respond to the second query based on said first response;
transmits a second set of signals to the at least one user device, wherein said second set of signals comprise the selected second query and one or more options to respond to the second query;
wherein one of said at least one user device is a smartphone; and
said enterprise system is implemented within a software as a service (SaaS) offering using a cloud-based implementation.

2. The system of claim 1, wherein
said generated first user interface comprising the first query and one or more options to respond to the first query.

3-4. (canceled)

5. The system of claim 1, wherein said data and commands to refresh said first user interface comprise data and commands to enable the display of the first query, the first response, the second query, and the options to respond to the second query.

6. A method for an online survey comprising:
transmitting, to at least one user device, a first set of signals comprising at least a first query and options to respond corresponding to said first query, said transmitting performed by a server, said server implemented using a cloud-based implementation, and said at least one user device coupled to said server by a network, wherein said first set of signals further comprise
data and commands to generate a first user interface at the said user device,
data and commands to refresh said first user interface at said user device, further wherein said data and commands to refresh said first user interface comprise data and commands to enable the disappearance of all of the options to respond to the first query, except for a first response selected by the user based on the options to respond corresponding to said first query;
receiving, at said server from said user device, the first response based on said options to respond;
responsive to receiving said first response, performing processing at said server, said processing comprising
selecting a second query, and options to respond to said second query;
transmitting a second set of signals to the at least one user device, wherein said second set of signals comprise the selected second query and one or more options to respond to the second query;
wherein one of said at least one user device is a smartphone; and
wherein said method is implemented within a SaaS offering,

7. The method of claim 6, wherein
said generated first user interface comprising the first query and one or more options to respond to the first query.

8.-9. (canceled)

10. The method of claim 6, wherein said data and commands to refresh said first user interface comprise data and commands to enable the display of the first query, the first response, the second query, and the options to respond to the second query.

11. An enterprise system for an online survey comprising:
a server implemented using a cloud-based implementation, and coupled to at least one user device by a network, said at least one user device utilized by a user wherein
said server performs a process comprising two or more repetitions, said process comprising at least one initial repetition followed by a final repetition,
wherein within each initial repetition, said server
transmits a current set of signals to the at least one user device, wherein said current set of signals comprise data and commands to enable the at least one user device to
generate a current user interface for display at said at least one user device, said generated current user interface comprising a current query and one or more options for said user to respond to the current query, and
refresh said current user interface at said user device based on a current response provided by said user, wherein said refreshing comprises the disappearance of all of the options to respond to the current query, except for the current response;
receives the current response from the user device; and
selects a next query for to the next repetition and one or more options to respond to the next query, the selecting of the next query based on said current response received from the user device.

12. A system for an online survey comprising:
a server implemented using a cloud-based implementation and coupled to at least one user device by a network, said at least one user device utilized by a user wherein
said server performs a process comprising two or more repetitions, said process comprising at least one initial repetition followed by a final repetition,
wherein within each initial repetition, said server
transmits a current set of signals to the at least one user device, wherein said current set of signals comprise data and commands to generate a current user interface at said at least one user device, said generated current user interface comprising the current query and one or more options for said user to respond to the current query;
receives the current response from the user device; and
performs processing of the received current response to
transmit data and commands to enable refreshing of the current user interface displayed at said at least one user device,
wherein said refreshing comprises the disappearance of all of the options to respond to the current query except for the current response, and
select a next query for the next repetition and one or more options to respond to the next query; and
wherein one of said at least one user device is a smartphone.

13. The system of claim 11, wherein said at least one user device comprises a smartphone.

14. The system of claim 11, further wherein said server changes number of remaining repetitions within said process based on the received current response.

15. The system of claim 12, further wherein said server changes number of remaining repetitions within said process based on the received current response.

16. The system of claim 11, wherein the selecting of the next query comprises selecting a type of query.

17. The system of claim 12, wherein the selecting of the next query comprises selecting a type of query.

18. The system of claim 11, wherein said one or more options for said user to respond to the current query comprises giving the user a choice to upload a file.

19. The system of claim 12, wherein said one or more options for said user to respond to the current query comprises giving the user a choice to upload a file.

20. The system of claim 18, wherein said file is an image.

21. The system of claim 19, wherein said file is a document.

22. The system of claim 18, wherein said one or more options for said user to respond to the current query further comprises a thumbs up icon and a thumbs down icon.

23. The system of claim 19, wherein said file is either an image or a document.

24. The system of claim 23, wherein said one or more options for said user to respond to the current query further comprises a thumbs up icon and a thumbs down icon.

25. The system of claim 23, wherein said one or more options for said user to respond to the current query further comprises at least one of
a thumbs up icon and a thumbs down icon; and
a like button and an unlike button.

26. The system of claim 24, further wherein
said server comprises a front-end server and back-end server,
said system further comprising a database to store data comprising
data corresponding to the user,
one or more queries, and
one or more options to respond to said one or more queries;
further wherein
said front-end server is coupled to the at least one user device by the network,
said front-end server performs the
transmitting of the current set of signals to the at least one user device,
receiving of the current response from the user device, and
transmitting, to the at least one user device, of the data and commands to enable refreshing of the current user interface displayed at said at least one user device;
said back-end server
performs said processing of the current response received by the front-end server,
retrieves said selected next query for the next repetition and said one or more options to respond to said selected next query from the database based on said processing, and
transmits said data and commands to enable refreshing of the current user interface displayed at said at least one user device to said front-end server, said data and commands generated based on said processing of the current response;
said front-end server resides on a first subnetwork;
said back-end server and database reside on a second subnetwork; and
said first subnetwork separated from said second subnetwork by a firewall.
